(19) United States
(12) Patent Application Publication
(10) Pub. No.: US 2005/0094855 A1
(43) Pub. Date: May 5, 2005

(54) Fingerprint imaging using a flat panel detector

(76) Inventors: Cesar H. Proano, Milpitas, CA (US); Ivan P. Mollov, Cupertino, CA (US)

Correspondence Address: Daniel E. Ovanezian;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/697,901

(22) Filed: Oct. 29, 2003

(51) Int. Cl. G06K 9/00

(52) U.S. Cl. 382/124

(57) ABSTRACT

A capacitance fingerprint imaging apparatus including an insulator layer and a pixel array coupled to a bottom surface of the insulator layer. Each pixel of the array has a storage capacitor and an electrode coupled to the bottom surface of the insulating layer. A charge may be driven from a finger into the storage capacitor through an electrode. A conductive structure may be adjacent the active area of the imager through which a small pulse is applied to the finger. The pulse may allow an increase in the charge difference between the pixels that have contact with the finger and the pixels that do not contact the finger. A pulse may also be applied to the other storage capacitor contact so that at every frame a combination of the charge from the storage capacitor driven by the finger and a constant charge due to the pulse will exit the capacitor.

### TECHNICAL FIELD

Embodiments of the invention relate to the field of fingerprint imaging and, in particular, to fingerprint imaging using a capacitance fingerprint detector.

### BACKGROUND

Among all the biometric techniques, fingerprint-based identification is the oldest method that has been successfully used in numerous applications. People are known to have unique, immutable fingerprints. A fingerprint is made of a series of ridges and troughs (furrows, valleys, etc.) on the surface of the finger. The uniqueness of a fingerprint can be determined by the pattern of ridges and troughs as well as the minutiae points. Minutiae points are local ridge characteristics that occur at either a ridge bifurcation or a ridge ending.

At present, there are several different technologies that can capture a fingerprint. Fingerprint technologies are based on the manner in which a fingerprint is captured rather than how the data is processed. Fingerprint technologies may be classified into four major groups: optical, ultrasound, thermal, and capacitance.

Optical fingerprint scanners use a process referred to as frustrated total internal reflection that takes a picture of the finger. The problem with optical fingerprint scanners is that they also take a picture of the dirt, grease, and other containments found on the finger. Thermal fingerprint scanners use infrared to sense the temperature differences between the ridges and valleys of the finger to create an image of the fingerprint. The performance of current thermal scanners is poor. Ultrasound fingerprint scanners scan a finger using high frequency sound waves to capture an image of the finger. Ultrasound can image through contaminates usually found on a finger to obtain a high quality image. However, current ultrasound fingerprint scanners are very costly. Capacitance fingerprint scanners sense the charge differences in the ridges and valleys of the finger to produce a good quality image. One problem with semiconductor based capacitance fingerprint scanners is the limitation of a small scan area. Semiconductor based capacitance fingerprint scanners use capacitive sensors consisting of an array of miniature capacitors integrated in a semiconductor chip. The scan area of current capacitor arrays is approximately 0.5 inches by 0.5 inches. Scanning such a small area of the finger may not be enough to accurately identify an individual.

Another type of capacitance fingerprint scanner described in U.S. Pat. No. 5,325,442 uses an array of sense electrodes that are connected to a drive circuit. The sense electrodes are covered by a dielectric material defining a sensing surface over which a finger whose print is to be sensed is placed. The presence of a finger surface portion on dielectric material over a sense electrode produces a respective capacitor whose capacitance is sensed. The ridges of a fingerprint may be in contact with or at least close to the surface of the dielectric material whereas the troughs are spaced farther away. A capacitor is formed by each sense electrode in combination with the respective overlaying portion of the finger surface. One problem with such a capacitance fingerprint scanner is that the finger surface is held at a ground potential. This may result in a poor quality image due to the low charge that may be driven from the finger into the sense electrodes.

### SUMMARY OF EMBODIMENTS OF THE INVENTION

An apparatus and method for capacitance fingerprint imaging is described. In one embodiment, the apparatus includes an insulator layer and a pixel array coupled to a bottom surface of the insulator layer. Each pixel of the pixel array has a storage capacitor and an electrode coupled to the bottom surface of the insulating layer. A charge may be driven from the finger into the storage capacitance through an electrode. In one embodiment, a conductive structure may be adjacent the active area of the imager in which a small pulse may be applied to the finger. The pulse may allow an increase in the charge difference between pixels that have contact with the finger and pixels that do not have contact (or lesser contact with) the finger. In another embodiment, a pulse may be applied to the other contact of the storage capacitor so that at every frame a combination of the charge from the storage capacitor driven by the finger and a constant charge due to the pulse will exit the capacitor.

Additional features and advantages of the apparatus will be apparent from the accompanying drawings and detailed description that follow below.

### BRIEF DESCRIPTION OF THE DRAWINGS

Embodiments of the present invention are illustrated by way of example, and not limitation, in the figures of the accompanying drawings in which:

FIG. 1 is a cross sectional view illustrating one embodiment of a section of a pixel array of a capacitance fingerprint scanner.

FIG. 2 illustrates one embodiment of a finger ridgeline coupled to a pixel array of a capacitance fingerprint scanner.

FIG. 3 illustrates one embodiment of capacitance fingerprint scanner having a conductive structure surrounding an active area.

FIG. 4 illustrates one embodiment of capacitance fingerprint scanner having an additional pulse applied directly to storage capacitors.

FIG. 5 illustrates a block diagram of one embodiment of a capacitance fingerprint scanning system.

### DETAILED DESCRIPTION

In the following description, numerous specific details are set forth such as examples of specific, components, processes, etc. in order to provide a thorough understanding of various embodiments of the present invention. It will be apparent, however, to one skilled in the art that these specific details need not be employed to practice various embodiments of the present invention. In other instances, well known components or methods have not been described in detail in order to avoid unnecessarily obscuring various embodiments of the present invention. The term “coupled” as used herein means directly connected or connected through one or more intervening components or circuits.

The steps discussed herein may be performed by hardware components or may be embodied in machine-executable instructions, which may be used to cause a general-purpose or special-purpose processor programmed with the instructions to perform the steps. Alternatively, the steps may be performed by a combination of hardware and software.

In one embodiment a computer program product, or software, may include a machine-readable medium having stored thereon instructions, which may be used to program a computer system (or other electronic devices) to perform a process according to the present disclosure. A machine-readable medium includes any mechanism for storing or transmitting information in a form (e.g., software, processing application) readable by a machine (e.g., a computer). The machine-readable medium may includes, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, optical, acoustical or other form of propagated signal (e.g., carrier waves, infrared signals, digital signals, etc.); or other type of medium suitable for storing electronic instructions.

Methods discussed herein may also be practiced in distributed computing environments where the machine-readable medium is stored on and/or executed by more than one computer system. In addition, the information transferred between computer systems may either be pulled or pushed across the communication medium connecting the computer systems.

An apparatus and method for capacitance fingerprint imaging is described. In one embodiment, the apparatus includes an insulator layer and a pixel array coupled to a bottom surface of the insulator layer. Each pixel of the pixel array has a storage capacitor and an electrode coupled to the bottom surface of the insulating layer. A charge may be driven from the finger into the storage capacitor through an electrode. In one embodiment, a conductive structure is adjacent the active area of the imager through which a pulse may be applied to the finger. The pulse may allow an increase in the charge difference between pixels that have contact with the finger and pixels that do not have contact (or lesser contact with) the finger. In another embodiment, a pulse may be applied to the other contact of the storage capacitor so that at every frame a combination of the charge from the storage capacitor driven by the finger and a constant charge due to the pulse will exit the capacitor.

The figures referenced below may be discussed with respect to an amorphous silicon (a-Si) thin film transistor (TFT) panel imager. It will be appreciated by one of skill in the art, however, that other types of imagers may be used, including but not limited to those having polycrystalline silicon (“p-Si”), organic semiconductor, or other material transistors.

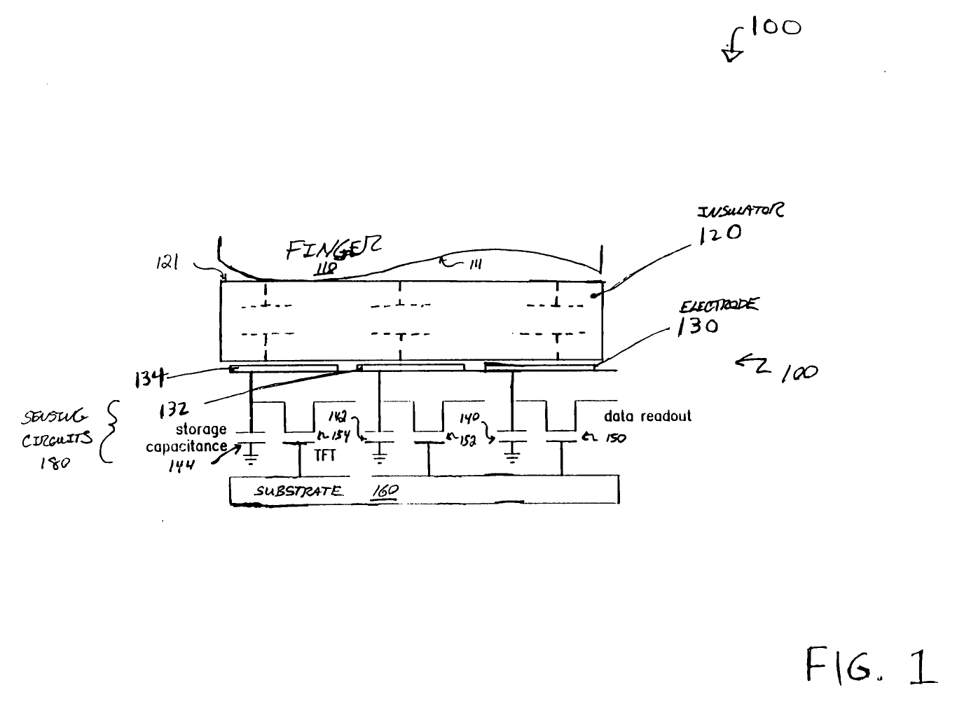

FIG. 1 is a cross sectional view illustrating one embodiment of a section of a pixel array of a capacitance fingerprint scanner. In operation of capacitance fingerprint scanner 100, a finger 110 is placed on surface 121. Finger 110 includes a series of ridges and troughs on its surface where a portion of a ridge 111 is depicted in FIG. 1. Either direct contact or close proximity results between ridge 111 and surface 121. The ridge 111 of finger 110 is spaced from an array of electrodes (e.g., electrodes 130, 132, 134) by a distance of the thickness of insulator 120. Troughs (not shown) in finger 110 are located farther away from the array of electrodes than ridge 111. Each of the electrodes 130, 132, 134 and the corresponding overlaying portion of ridge 111 of finger 110 form opposing plates of a capacitor as depicted by the dashed lines in insulator 120. The insulator 120 material and any air gap between ridge 111 and the electrodes 130, 132, and 134 provide the capacitor dielectric. The value of the individual capacitors varying as a function of the spacing between an electrode and an overlying ridge 111. Larger capacitances exist where the portions of ridges 111 are in contact with surface 121 (e.g., overlying electrode 134) and smaller capacitances exist where troughs overlie an electrode. As such, the finger 110 surface features provide different charge to each pixel in the array. The different charges generated by these capacitances are measured by sensing circuits 180 of the pixel array with corresponding signals output to produce an image of the fingerprint, as discussed below.

Capacitance fingerprint scanner 100 includes insulator 120, sensing circuits 180, and substrate 160. Substrate 160 supports sensing circuits 180. In one embodiment, substrate 160 may be a glass or comparable material known in the art such as ceramic or flexible materials (e.g., Kapton®, Mylar® made by Dupont of Wilmington, Del., other plastic based materials, etc.).

Sensing circuits 180 include active and passive devices configured in an array of pixels to sense and readout a charge received through the electrodes. Only three electrodes 130, 132, 134 and their corresponding sensing circuits are shown for ease of illustration. Capacitance fingerprint scanner 100 includes more than three electrodes and corresponding sensing circuits to form the pixel array. A pixel may be formed by a pixel electrode (e.g., electrodes 130, 132, 134), a capacitor (e.g., capacitors 140, 142, 144), and an active readout device (e.g., transistors 150, 152, 154). Each electrode (e.g., electrode 130) is coupled to a corresponding capacitor (e.g., capacitor 140) and a readout device (e.g., readout device 150). In the illustrated embodiment of FIG. 1, readout devices 150, 152, 154 are thin film transistors (TFT). A sensing apparatus of this type may also be referred to as a TFT flat panel detector (“FPD”). Alternatively, capacitance fingerprint scanner 100 may have other types of readout devices, for examples, polycrystalline silicon (“p-Si”) or organic semiconductor transistors. In yet another embodiment, single and/or double switching diodes (e.g., as in Trixell panels) may be used for the active devices.

Insulator 120 is disposed over the electrodes 130, 132 and 134 to provide a continuous sensing surface 121. Finger 110 may be capacitively coupled to the pixel array of capacitance fingerprint scanner 100 through insulator 120. Insulator 120 may be any number of materials known in the art to electrically separate finger 110 from the pixels, for example, silicon nitride. In one particular embodiment, insulator 120 may be a polyimide film such as Kapton®. In another embodiment, other insulating materials such as Mylar® may be used. The thickness of insulator 120 may be selected based on the particular material used. In embodiment, for example, insulator 120 may have a thickness of approximately 25 microns with a capacitance of 0.003 Pico Farads (pF). Alternatively, other thickness and capacitance for insulator 120 may be used.

In an alternative embodiment, insulator 120 may include several layers of varying material. In one exemplary embodiment, a bottom layer may be Kapton with a top layer of Mylar. The Mylar layer could be replaced over time if damaged from repeated contact with finger 10. Bottom layer can also have a permanent layer of black matrix. In addition to providing capacitive coupling, insulator 120 provides a mechanical, protective layer between finger 110 and pixel electrodes 130, 132, 134. Because finger 110 is physically pressed against insulator 120, a thick insulator may prevent damage to pixels 130, 132, 134. However, a balance between providing adequate protection and an appropriate sensitivity level of pixels 130, 132, 134 should be taken into consideration because the thicker the insulator, the smaller the value of the coupling capacitance through the insulator 120 resulting in a smaller charge detected in comparison to the noise signal (S/N ratio decreases).

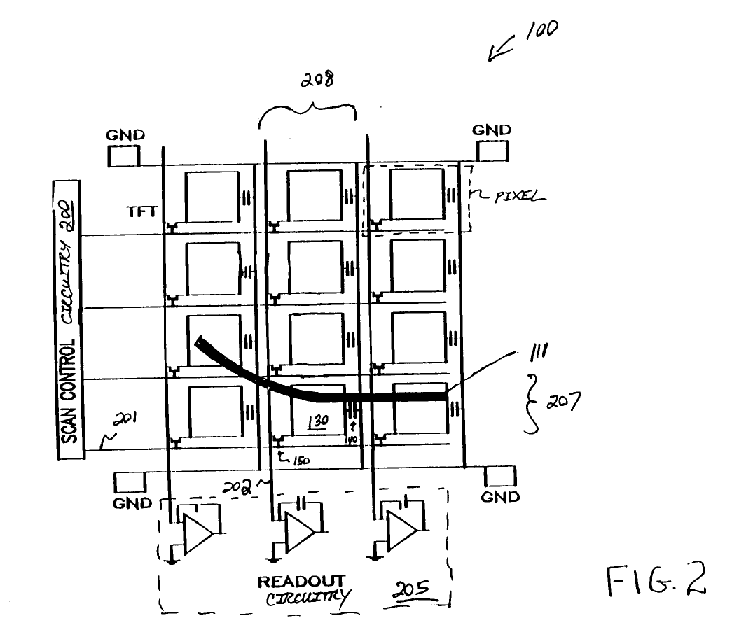

As previously mentioned, the finger 110 surface features provide different charge to each pixel in the array. When finger 110 has a potential, an electrical charge develops between the pixel electrodes and overlying areas of finger 110 and is stored in the capacitors of the sensing circuit 180, for example, capacitor 140. In one embodiment, capacitor 140 may have a capacitance of approximately 1 pF. Alternatively, other capacitances may be used. The charge on storage capacitor 140 may be read out with transistor 150 that is coupled to data line and readout circuits. At an appropriate time, the control input (e.g., transistor gate) of readout device 150, 152, 154 activates and reads out the charge on the storage capacitors. This charge is further amplified and processed for a corresponding pixel using readout circuitry, as discussed below in relation to FIG. 2.

FIG. 2 illustrates one embodiment of a finger ridgeline coupled to a pixel array of a capacitance fingerprint scanner. Capacitance fingerprint scanner 100 has an array of sensing elements arranged in a row and column format. Each sense element may include an electrode (e.g., electrode 130) a capacitor (e.g., capacitor 140) and a readout device (e.g., transistor 150). The size of each sensing element may be based on a desired resolution for the fingerprint scanner. For example, each sensing element may have a pitch (electrode plus gap) of approximately 127 microns by 127 microns. Alternatively, smaller or large pitch dimensions may be used.

The array of sensing elements may be addressed by sets of row and column conductor lines (e.g., lines 201 and 202). In one embodiment, all the transistors in the same column (e.g., column 208) may be coupled to a common data readout line (e.g., line 202) and all the transistors in a same row (e.g., row 207) may be coupled to a common row conductor line (e.g., line 201). The row conductor lines are coupled to scan control circuitry 200. Each sensing element may be addressed, or selected, through an associated row conductor line (e.g., line 201) and a column conducting line (e.g., line 202) using scan control circuitry 200 and readout circuitry 205. Scan control circuitry and readout circuitry are known in the art; accordingly, a detailed discussion is not provided.

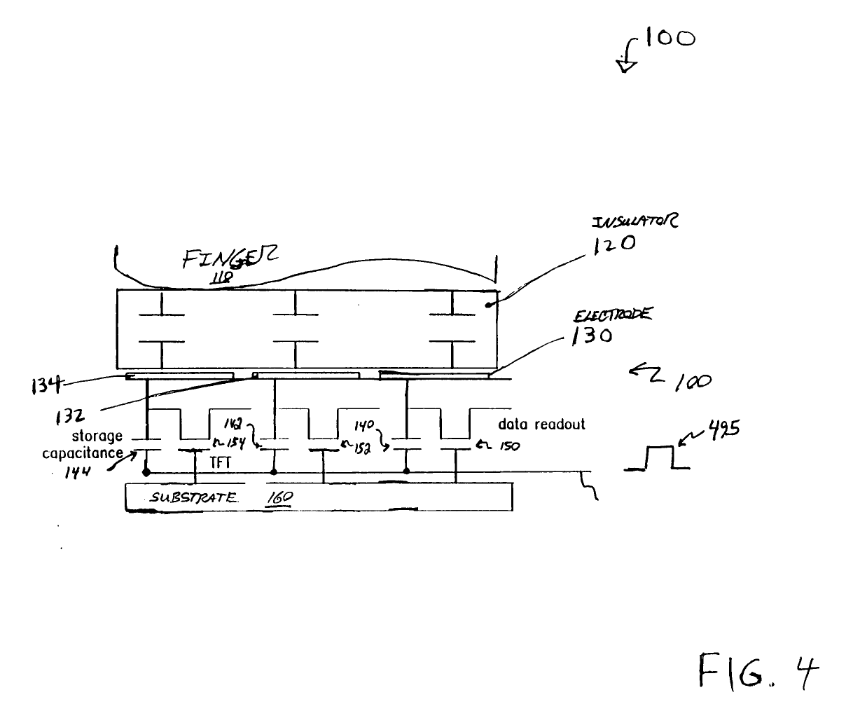

In one particular exemplary embodiment, capacitance fingerprint scanner 100 may include an array of 2,949,120 pixels arranged in a matrix of 1920 by 1536 pixels. Each pixel may be, for example, 127 microns by 127 microns, thereby determining an active area (339 of FIG. 4) of 25 centimeters (cm) by 20 cm. Such an active area may be used to scan the fingerprints of an entire hand. Alternatively, capacitance fingerprint scanner 100 may include other numbers of pixels and array configurations that form a large active area or a smaller active area (e.g., to scan a single fingerprint).

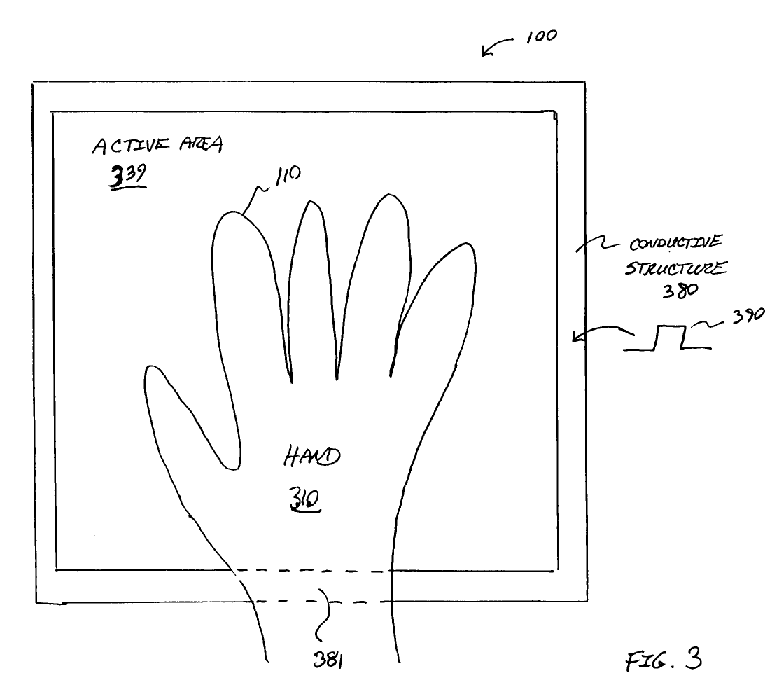

FIG. 3 illustrates one embodiment of capacitance fingerprint scanner having a conductive structure surrounding an active area. In this embodiment, a charge is driven into the fingers (e.g., finger 110) of hand 310 through a conductive structure 380 surrounding active area 339. Hand 310 is placed on capacitance fingerprint scanner 100 such that a portion 381 of conductive structure 380 is in contact hand 310 (e.g., at approximately the palm or wrist). It should be noted that conductive structure 380 need not surround active area 339. In an alternative embodiment, the conductive structure may be a piece underneath the contacting portion 381 of hand 310. In another embodiment, the conductive structure need not be in contact with the active area 339. In particular, the conductive structure may be adjacent to the pixel array but physically separate from active area 339 at a location that may still be physically contacted by a user's hand 310 or other part of the body.

In one embodiment, the charge driven into finger 110 is produced using a pulse 390 that enables the capacitors in scanner 100 to be charged. In one particular embodiment, the pulse may have an alternating voltage of, for example, −1 volt (V) to −0.5 V. Alternatively, other voltages and other voltage waveforms (e.g., one-shot, ramp, etc.) may be used. In an alternative embodiment, for example, a positive alternating voltage may be used. It should be noted that any signal may be used that changes its voltage amplitude between two readouts of scanner 100.

Driving a charge into finger 110 may allow for an increase in the magnitude of the different charges stored in sensing circuits 180 (e.g., capacitors 140, 142 and 144) between pixels that have direct contact with finger 110 (e.g., pixel 134 of FIG. 1) and pixels that do not have direct contact with finger 110.

Active area 339 is illustrated in FIG. 3 with a dimension large enough to simultaneous image all the fingers of hand 310. In an alternative embodiment where capacitance fingerprint scanner 100 has a smaller active area 339, for example, to scan a single finger, the contact area 381 of conductive structure may make contact with only the finger portion of hand 480.

FIG. 4 illustrates an alternative embodiment of capacitance fingerprint scanner having an additional pulse applied directly to the storage capacitors. In this embodiment, a second pulse 495 may be applied directly to the storage capacitors (e.g., capacitors 140, 142, and 144) of scanner 100 such that the sensing circuits 180 (e.g., capacitors 140, 142 and 144) store charge driven through finger 110 and also a constant charge due to pulse 495. The pulse 495 is applied directly to the charge storage capacitors of sensing circuits 180 (e.g., capacitors 140, 142 and 144) through the contact plates of the charge storage capacitors opposite the contact plates coupled to the electrodes (e.g., electrodes 130, 132, and 134). In this manner, at every frame of fingerprint image scan, a pulse will exit the sensing circuits 180 (e.g., capacitors 140, 142, and 144) that will be the same to all pixels in the array. At places where finger 110 contacts the active area 339, part of the charge injected into capacitors 140, 142, and 144 by pulse 390 applied to the conductive structure 380 is driven to the body, with the remaining charge read by sensing circuit 180. In places where finger 110 does not make contact with active area 339, sensing circuit 180 will read the charge applied to capacitors 140, 142, and 144 generated by pulse 495. In this manner, at every frame, a charge will be read out from the capacitors 140, 142, and 144. The additional charge generated by pulse 495 will be the same to all pixels in the array. A better quality image of finger 110 may thereby be obtained based on this charge appreciation.

The pulse 495 applied to capacitors 140, 142, and 144 may have any reference value. In one embodiment, for example, pulse 495 may have an alternating voltage of, for example, approximately −8.5 V to −8 V. Although the voltage difference for this embodiment is 0.5V, other voltage ranges may be used (e.g., 1 V or higher) with the constraint that the charge driven into the amplifier does not exceed the absolute maximum value of the electronic components of scanner 100. Alternatively, other voltages (e.g., positive) may be used.

It should be noted that capacitance fingerprint scanner 100 may have other configurations. In an alternative embodiment, for example, two of the pixel electrodes (e.g., electrodes 130 and 132) may be used to measure the difference in parasitic capacitance of insulator 120 between them. The finger ridgeline 111 across the electrodes generates a capacitance whereas as a trough across the electrodes creates less capacitance (or substantially no capacitance).

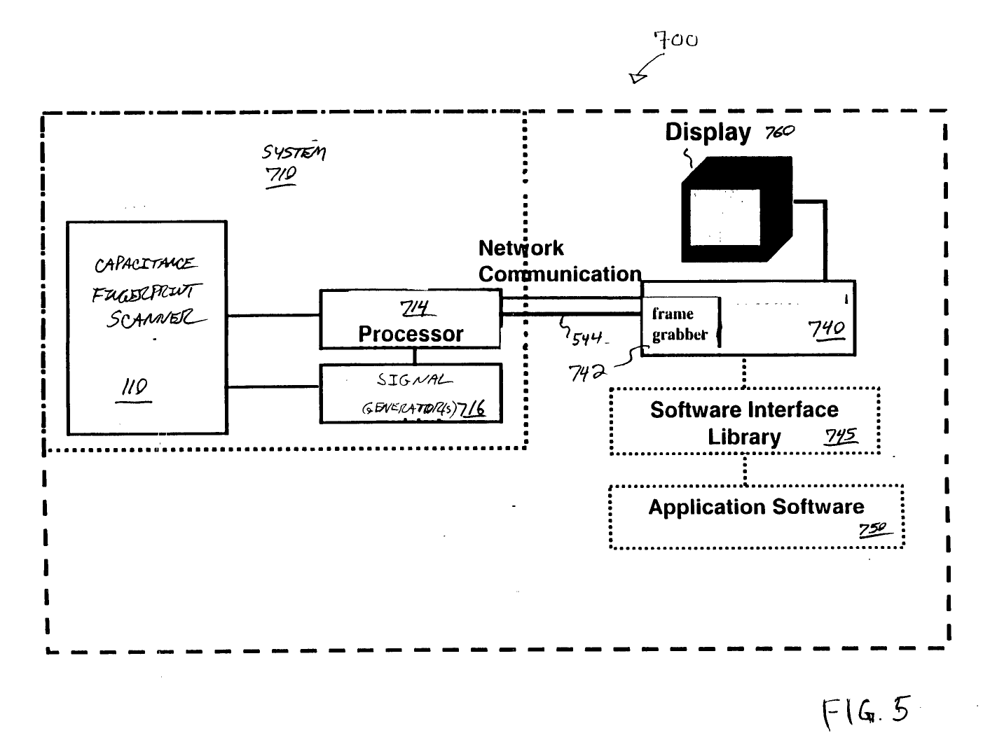

FIG. 5 illustrates a block diagram of a fingerprint identification system 700 that includes the capacitance fingerprint scanner 110 described with respect to FIGS. 1-4. In this embodiment, capacitance fingerprint scanner 100 is coupled to processor 714 and signal generator(s) 716 to form a capacitive fingerprint scanner system 710. Processor 714 includes the control system or the operating software that controls scan function. Processor 714 also may serve as the interface to a workstation 740 that receives image data 544 from processor 714. Signal generator(s) 716 represents one or more signal generators that may be coupled to both processor 510 and capacitance fingerprint scanner 110 to provide one or more signals (e.g., pulse 390, pulse 495, one-shot, constant voltage signal, etc.) to fingerprint scanner 110. Signal generators and processors are known in the art; accordingly, a detailed description is not provided.

Processor 714 also may communicate data (e.g., with a network communication device) with a workstation 740 (e.g., a computer) to transmit data from capacitance fingerprint scanner 712 including video data to view an image of a fingerprint on display 760. For example, processor 714 also may include an analog to digital converter (ADC) to generate an analog video signal and/or video drive to generate a digital video signal. Workstation 740 may include frame grabber module 742 so that data, corresponding to signals generated from processor 714, may be interpreted by a user in the form of a video image. In one embodiment, for example, a 16-bit video port connection from processor to workstation 740 provides real time images to be captured by frame grabber 742 and viewed with display 760. Processor 714 may also include hardware handshaking port 770 for synchronizing the hardware of processor 714 with workstation 740. Workstation 740 may also utilize software interface library 745 and software 750 to process video data communicated from processor 714, for example, for identification of a fingerprint or comparison to other fingerprints. The processing of fingerprint information to identify and compare characteristic features of fingerprints is known in the art; accordingly, a detailed discussion is not provided.

It should be noted that the architecture illustrated in FIG. 5 is only exemplary. In alternative embodiments, other architectures may be used. For example, various components may be integrated or coupled in other manners.

In the foregoing specification, the invention has been described with reference to specific exemplary embodiments thereof. It will, however, be evident that various modifications and changes may be made thereto without departing from the broader spirit and scope of the invention as set forth in the appended claims. The specification and figures are, accordingly, to be regarded in an illustrative rather than a restrictive sense.

1. An apparatus, comprising:
an insulator having a bottom surface;
a pixel array coupled to the bottom surface of the insulator;
a conductive structure adjacent to the pixel array; and
a first signal generator coupled to the conductive structure.

2. The apparatus of claim 1, wherein the pixel array comprises amorphous silicon (a-Si) transistors.

3. The apparatus of claim 3, wherein the a-Si pixel array is the basis for a thin film transistor (“TFT”) flat panel detector.

4. The apparatus of claim 1, wherein the conductive structure is configured to reside underneath a contacting portion of a hand.

5. The apparatus of claim 1, wherein the first signal generator is configured to drive a charge through the insulator.

6. The apparatus of claim 5, wherein the first signal generator generates a pulse.

7. The apparatus of claim 6, wherein the pulse has a negative potential.

8. The apparatus of claim 5, wherein the first signal generator generates a signal that changes its voltage amplitude.

9. The apparatus of claim 1, further comprising
a plurality of electrodes coupled to the insulator; and
a plurality of storage capacitors, each of the plurality of storage capacitors coupled to a corresponding one of the plurality of electrodes; and
a second signal generator coupled to the plurality of storage capacitors on a side opposite that of the plurality of electrodes.

10. The apparatus of claim 9, wherein the second signal generator is configured to drive a charge directly into the plurality of storage capacitors through the side opposite that of the plurality of electrodes.

11. The apparatus of claim 10, wherein the second signal generator generates a pulse.

12. The apparatus of claim 11, wherein the pulse has a negative potential.

13. The apparatus of claim 9, wherein the second signal generator is configured to drive a first charge through the side opposite that of the plurality of electrodes into the plurality of storage capacitors, and wherein the first signal generator is coupled to the conductive structure to drive a second charge through the insulator.

14. The apparatus of claim 1, wherein the conductive structure surrounds the pixel array.

15. A fingerprint recognition system comprising the apparatus according to claim 1.

16. A method, comprising:
capacitively coupling a finger with a pixel array, wherein the pixel array comprises:
an insulator;
a plurality of electrodes coupled to the insulator; and
a plurality of storage capacitors, each of the plurality of storage capacitors coupled to a corresponding one of the plurality of electrodes;
driving a first charge through the finger into at least one of the plurality of storage capacitors.

17. The method of claim 16, wherein the first charge is driven through the finger using a first pulse.

18. The method of claim 17, wherein the first pulse has a negative voltage.

19. The method of claim 16, wherein the first charge is driven into a first contact of the storage capacitor coupled to a corresponding electrode.

20. The method of claim 19, further comprising driving a second charge into a second contact of the storage capacitor.

21. The method of claim 20, wherein the second charge is driven directly into the storage capacitor using a pulse.

22. The method of claim 21, wherein the pulse has a negative voltage.

23. The method of claim 17, further comprising driving a second charge into a second contact of the storage capacitor, wherein the second charge is driven directly into the storage capacitor using a second pulse.

24. The method of claim 17, wherein the first pulse has a positive voltage.

25. The method of claim 17, wherein the first pulse has a voltage difference in the approximate range of 0.5V to 1V.

26. An apparatus, comprising:
means for sensing a capacitance of a finger contact with a pixel array having a plurality of storage capacitors; and
means for driving a first charge through the finger into a first contact of at least one of the plurality of storage capacitors.

27. The apparatus of claim 26, further comprising means for driving a second charge into a second contact of the at least one of the plurality of storage capacitors.
